(19) United States
(12) Patent Application Publication
(10) Pub. No.: US 2025/0026066 A1
(43) Pub. Date: Jan. 23, 2025

(54) CONTAINER TREATMENT SYSTEM FOR REGULATING A TEMPERATURE OF A PREFORM

(71) Applicant: Krones AG, Neutraubling (DE)

(72) Inventors: Florian GELTINGER, Donaustauf (DE); Andreas MEYER, Parkstetten (DE); Jochen HIRDINA, Regensburg (DE)

(21) Appl. No.: 18/774,352

(22) Filed: Jul. 16, 2024

(30) Foreign Application Priority Data
Jul. 19, 2023 (DE) 10 2023 119 045.8

(51) Int. Cl. B29C 49/78; B29C 49/06; B29D 22/00

(52) U.S. Cl. CPC B29C 49/786; B29C 49/064; B29D 22/003; B29C 2049/7861; B29C 2791/001; B29C 2791/003

(57) ABSTRACT

The present disclosure relates to a container treatment system for regulating a temperature of a preform, wherein the container treatment system comprises a production machine for producing a preform, in particular an injection molding machine, a heating apparatus arranged downstream of the production machine, a blow molding machine arranged downstream of the heating apparatus, and a control unit, wherein the control unit is configured to regulate an operating parameter of at least one component of the container treatment system based on an actual temperature of the preform at a position upstream of the blow molding machine in order to achieve a target temperature of the preform at the blow molding machine.

### CROSS REFERENCE TO RELATED APPLICATION

The present application claims priority to German Patent Application No. 10 2023 119 045.8 filed on Jul. 19, 2023. The entire contents of the above-listed application are hereby incorporated by reference for all purposes.

### TECHNICAL FIELD

The present disclosure relates to a container treatment system for regulating a temperature of a preform and a corresponding method.

### BACKGROUND

The molding of containers from preforms using a blow molding method is known from the prior art. An injection molding method is typically used to produce the preforms.

### SUMMARY

In the prior art, the production of the preforms and the molding of the preforms into a container take place separately in terms of time and location.

Thus, in addition to a blow molding machine, container treatment systems from the prior art typically comprise a storage apparatus in which the finished preforms are stored as bulk material. The blow molding machine can be continuously supplied with preforms via the storage apparatus, so that the continuous production of containers can be guaranteed. In order to be able to feed the preforms to the blow molding machine from the storage unit in an orderly manner, they are first separated and/or aligned using a sorting apparatus. After the preforms have been formed into containers, further treatment steps can be carried out on the containers in downstream process steps, such as coating, filling, labeling, printing, and/or sealing.

However, the production of preforms and their further processing, separated in terms of time and location, into containers, as known from the prior art, has a number of disadvantages. For example, the preforms can be damaged by the transportation to the container treatment system or by the storage as bulk material in the storage apparatus of the container treatment system, which in turn can have a negative impact on the quality of the containers produced from the preforms. In addition, transporting or storage the preforms can be associated with high costs and can cause unwanted contamination of the preforms.

### Object

Based on the known prior art, the technical object to be achieved by the present disclosure is to make the production process of containers from preforms more efficient and at the same time to improve the quality of the containers produced.

### Achievement

This object is achieved according to the disclosure by the container treatment system for regulating a temperature of a preform as described herein.

The container treatment system according to the disclosure for regulating a temperature of a preform comprises a production machine for producing a preform, in particular an injection molding machine, a heating apparatus arranged downstream of the production machine, a blow molding machine arranged downstream of the heating apparatus, and a control unit, wherein the control unit is configured to regulate an operating parameter of at least one component of the container treatment system based on an actual temperature of the preform at a position upstream of the blow molding machine in order to achieve a target temperature of the preform at the blow molding machine.

An arrangement downstream of the production machine or the heating apparatus is to be understood here as an arrangement downstream of the production machine or the heating apparatus in relation to a transport direction of the preforms.

The production machine can be set up to process plastic materials of any kind and can be configured to produce preforms. The plastics material can be polyethylene terephthalate (PET), polyethylene (PE), or polypropylene (PP), for example. However, it can also be any other plastics material suitable for producing a preform.

The production machine can be in particular an injection molding machine. Alternatively, it can also be an apparatus for producing preforms by means of a compression molding method or an apparatus for producing preforms by means of an injection compression molding method. However, it can also be any other apparatus suitable for producing a preform.

The heating apparatus can be any heating apparatus which is configured to heat a preform to at least a temperature value that corresponds to at least the target temperature. For example, the heating apparatus can be designed as an electric resistance heater, which can comprise a plurality of incandescent lamps. Alternatively or additionally, the heating apparatus can also comprise an infrared or microwave heating apparatus, for example. In one embodiment, it can be provided that the heating apparatus is configured to generate a specific temperature profile in the preform, for example along its longitudinal axis. However, the heating apparatus can also be designed to heat the preform evenly to a specific temperature.

The blow molding machine can be designed as an extrusion blow molding machine or stretch blow molding machine, for example. Optionally, the blow molding machine is designed to form the preforms into containers. The containers are optionally bottles used in the beverage industry. However, they can also be any other container, such as cans, jars, cups or tubes, for example, as used in the beverage, pharmaceutical, healthcare or food industries, or any other container which can be suitable for holding any liquid or pasty medium.

The actual temperature of the preform can be, for example, an actual temperature at a specific surface position of the preform, an actual temperature distribution, for example along a longitudinal axis of the preform, or an average temperature value of the preform.

The same applies to the target temperature of the preform.

The position of the preform upstream of the blow molding machine can be any position that the preform passes through during transport from the production machine via the heating apparatus to the blow molding machine. For example, the position can be the outlet of the production machine or an outlet of the heating apparatus. However, it can also be any other position between the production machine and the blow molding machine.

Reaching the target temperature at the blow molding machine is to be understood in such a way that the target temperature of the preform is to be reached at any position of the blow molding machine before the preform is formed into a container. The arbitrary position of the blow molding machine can be, for example, an inlet of the blow molding machine, a position in the blow molding machine between the inlet of the blow molding machine and the position at which the preform is transferred to a blow mold, or a position of a transport direction assigned to the blow molding machine, by means of which the preforms can be transported to the blow molding machine, for example.

A component can be any part of the container treatment system whose operation can be regulated by means of an operating parameter. For example, the component can be the production machine, the heating apparatus, or any other container treatment machine of the container treatment system not explicitly mentioned here. Alternatively, the component can also be, for example, a transport apparatus by means of which the preforms can be transported from the production machine to the heating apparatus or from the heating apparatus to the blow molding machine.

An operating parameter is to be understood in particular as a machine parameter of a component of the blow molding machine, the regulation of which can influence the temperature of the preform.

The operating parameter can also be understood as a composition of a material for producing the preforms in the production machine. As already described above, the material can be for example a plastics-based material which can comprise other components in addition to a plastics material. In this case, regulating the operating parameter can be understood to mean changing the composition of the material by adding at least one of an additive, plastics material flakes of a particular particle size, plastics material flakes of a particular particle size distribution, recyclate, recycled polyethylene terephthalate (PET), and/or color particles. The selection of material components just mentioned is not to be understood as limiting, so that other material components not explicitly mentioned here can also be added to the material in order to modify the material composition.

The container treatment system according to the disclosure can be used to produce a preform and process it into a container. This prevents damage and contamination to the preforms and the containers produced from them due to transportation and storage, saves transportation costs, and at the same time improves the quality of the containers produced. By regulating the temperature of the preform based on an actual value to generate a target temperature at the blow molding machine, the quality of the formed containers can be improved.

In one embodiment, the at least one component can comprise the heating apparatus and the operating parameter can be a heating power, a heating profile, and/or a heating duration of the heating apparatus. The heating apparatus allows for particularly flexible and simple regulation of the temperature of the preform. The heating power, the heating profile, and/or the heating duration of the heating apparatus are directly related to the temperature of the preform and are therefore suitable operating parameters for generating a target temperature of the preform.

In one embodiment, the at least one component can comprise the production machine for producing the preform. By regulating an operating parameter of the production machine, the temperature of the preform output by the production machine can be flexibly adjusted, and in this way a specific target temperature of the preform can be achieved at the blow molding machine.

In a further development of this embodiment, the operating parameter can be a cycle time, an injection time, a lock to lock time, a production tool temperature, a melting temperature, a post-cooling temperature of the production machine, and/or a composition of a material for producing the preforms in the production machine. Cycle time refers to the time it takes to produce a preform with the production machine. The production tool temperature is the temperature of a production tool of the production machine in which the preform is manufactured. The melting temperature is the temperature at which the material, for example a plastics material, is melted in the production machine to produce the preform, and the post-cooling temperature is the temperature to which the preform can be cooled after production using post-cooling units. The lock to lock time is the time required for the production tool to open and close. During this time, no preforms can be produced in the production machine, so that the lock to lock time can be equated to a dead time. Since these operating parameters of the production machine have a direct influence on the temperature at which the preform is output from the production machine, these operating parameters are particularly suitable for regulating the temperature of the preform in order to achieve a target temperature at the blow molding machine.

In one embodiment, the control unit can be configured to regulate an operating parameter of the heating apparatus and an operating parameter of the production machine if the actual temperature is below or above a threshold value. If the actual temperature of the preform is below a threshold value, it can be necessary that the regulation of an operating parameter of the production machine or heating apparatus is not sufficient to achieve the target temperature of the preform at the blow molding machine. By regulating an operating parameter of the production machine and the heating apparatus, it can also be ensured in this case that the target temperature of the preform is reached at the blow molding machine, and that the preforms can be formed into containers of the desired quality.

In one embodiment, the at least one component can comprise a first transport apparatus arranged between the production machine and the heating apparatus and/or a second transport apparatus arranged between the heating apparatus and the blow molding machine. By regulating an operating parameter of the first and/or second transport apparatus, a temperature change of the preforms during their transport between the production machine and the heating apparatus or between the heating apparatus and the blow molding machine can be controlled (for example by controlling the transport speed and the resulting transport duration), and in this way the target temperature of the preforms at the blow molding machine can be achieved.

In a further development of this embodiment, the operating parameter can be a transport speed, a prevailing ambient temperature at the first and/or second transport apparatus, and/or a number of preforms which are transported by the first and/or second transport apparatus within a particular time interval. Since these operating parameters of the first and/or second transport apparatus have a direct influence on the temperature of the preforms at the blow molding machine, the regulation of these parameters is particularly suitable for achieving a specific target temperature of the preforms at the blow molding machine.

According to the disclosure, a method for regulating a temperature of a preform in a container treatment system is also provided, wherein the container treatment system comprises a production machine for producing the preform, in particular an injection molding machine, a heating apparatus arranged downstream of the production machine, a blow molding machine arranged downstream of the heating apparatus, and a control unit, and an operating parameter of at least one component of the container treatment system is regulated by the control unit on the basis of an actual temperature of the preform at a position upstream of the blow molding machine, so that a target temperature of the preform is reached at the blow molding machine.

By producing and further processing the preforms in one system, damage and contamination of the preforms and the containers produced from them due to transportation or storage can be prevented, transport costs can be saved, and at the same time the quality of the containers produced can be improved. In addition, by generating a target temperature at the blow molding machine, containers with a particularly uniform wall thickness distribution can be produced, thus improving the quality of the containers.

In one embodiment, the at least one component can comprise the heating apparatus and the operating parameter can be a heating power, a heating profile, and/or a heating duration of the heating apparatus. By means of the heating apparatus and the regulation of the heating power, the heating profile, and/or the heating duration, the temperature of the preform can be set flexibly and easily and in this way the target temperature of the preform can be achieved at the blow molding machine.

In one embodiment, the at least one component can comprise the production machine for producing the preform. By regulating an operating parameter of the production machine, the temperature of the preform output by the production machine can be flexibly and easily adjusted so that a specific target temperature can be achieved at the blow molding machine

In a further development of this embodiment, the operating parameter can be a cycle time, an injection time, a lock to lock time, a production tool temperature, a melting temperature, a post-cooling temperature of the production machine, and/or a composition of a material for producing the preforms in the production machine. Since these operating parameters of the production machine have a direct influence on the temperature of the preform output by the production machine, they are particularly suitable for regulating the temperature of the preform and thus achieving a target temperature of the preform at the blow molding machine.

In one embodiment, an operating parameter of the heating apparatus and an operating parameter of the production machine can be regulated by the control unit if the actual temperature is below or above a threshold value. If the actual temperature of the preform is below a threshold value, the regulation of an operating parameter of the production machine or of an operating parameter of the heating apparatus may not be sufficient to reach the target temperature of the preform at the blow molding machine. By regulating an operating parameter of the production machine and the heating apparatus, it can be ensured in this case as well that the target temperature of the preform is reached at the blow molding apparatus and that the preforms are formed into containers of the desired quality.

In one embodiment, the at least one component can comprise a first transport apparatus arranged between the production machine and the heating apparatus and/or a second transport apparatus arranged between the heating apparatus and the blow molding machine. By regulating an operating parameter of the first and/or second transport apparatus, a temperature change of the preforms during their transport between the production machine and the heating apparatus, or between the heating apparatus and the blow molding machine, can be controlled, and in this way the target temperature of the preforms at the blow molding machine can be achieved.

In a further development of this embodiment, the operating parameter can be a transport speed of the first and/or second transport apparatus, an ambient temperature prevailing at the first and/or second transport apparatus and/or a number of preforms which are transported by the first and/or second transport apparatus. Since these operating parameters of the first and/or second transport apparatus have a direct influence on the temperature of the preforms at the blow molding machine, the regulation of these parameters is particularly suitable for achieving a specific target temperature of the preforms at the blow molding machine.

In one embodiment, the actual and/or target temperature can be an actual and/or target temperature distribution of the preform. By generating a target temperature distribution of the preforms at the blow molding machine, the blow molding behavior of the preforms can advantageously be improved, and a container with a particularly uniform wall thickness distribution can be produced. In this way, potential deviations in the shape of the manufactured container from an ideal shape can be minimized.

### BRIEF DESCRIPTION OF THE FIGURE

FIG. 1 shows a container treatment system for regulating a temperature of a preform according to one embodiment.

### DETAILED DESCRIPTION OF THE FIGURE

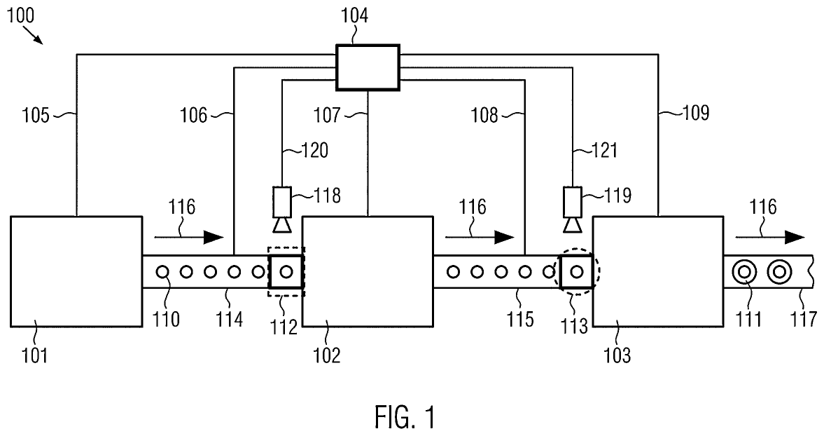

FIG. 1 shows a container treatment system 100 for regulating a temperature of a preform 110 according to one embodiment.

According to the disclosure, the container treatment system 100 comprises a production machine 101, a heating apparatus 102 arranged downstream of the production machine 101 with respect to a transport direction 116 of the preform 110, a blow molding machine 103 arranged downstream of the heating apparatus 102 in the transport apparatus 116 of the preform 110, and a control unit 104.

According to the disclosure, the control unit 104 (such as a computer with processor and associated memory) is configured to regulate an operating parameter of at least one component of the container treatment system 100 based on an actual temperature of the preform 110 at a position 112 upstream of the blow molding machine 103 in order to achieve a target temperature of the preform 110 at the blow molding machine 113.

Also shown is an optional first transport apparatus 114 between the production machine 101 and the heating apparatus 102, which transport apparatus is provided for transporting the preforms 110 from the production machine 101 to the heating apparatus 102, and an optional second transport apparatus 115 between the heating apparatus 102 and the blow molding machine 103, which transport apparatus is provided for transporting the preforms 110 from the heating apparatus 102 to the blow molding machine 103. Also optionally, a third transport apparatus 117 can be provided downstream of the blow molding machine 103 in the transport direction 116 of the containers 111. By means of the third transport apparatus 117, the containers 111 can be further transported to at least one further container treatment machine, which is not explicitly shown here.

The at least one container treatment machine can be, for example, an apparatus for pretreating containers 111, for example by means of a plasma or corona method, a filler for filling the containers 111 with a beverage or another liquid, a labeling apparatus, a direct printing apparatus, and/or a capper. However, it can also be any other apparatus not explicitly mentioned here that is suitable for treating containers 111.

In the embodiment discussed here, the optional transport apparatuses 114, 115, 117 are designed as linear transport apparatuses. In an alternative embodiment, it is also possible for the transport apparatuses to be designed as rotating stars.

The production machine 101 can be set up to process plastics materials of any kind and can be configured to produce preforms 110. For example, the production machine 101 can be designed to process polyethylene terephthalate (PET) or to produce preforms 110 from PET. Alternatively, the production machine 101 can also be configured for example to process polyethylene (PE) or polypropylene (PP) and for producing preforms 110 from PE or PP. However, these examples are not to be understood as limiting, so that any other plastics material suitable for producing a preform 110 can also be processed by the production machine 101 to form a preform 110. In one embodiment, the production machine 101 can comprise a plurality of production tools, wherein each production tool has at least one cavity. The shape of the cavity represents a negative impression of the preform 110 produced by the production machine 101. The various production tools can comprise differently designed cavities, so that the production machine 101 can be used flexibly and can be configured to produce preforms 110 of different types.

The production machine can be in particular an injection molding machine. Alternatively, it can also be an apparatus for producing preforms by means of a compression molding method or an apparatus for producing preforms by means of an injection compression molding method. However, it can also be any other apparatus suitable for producing a preform.

The heating apparatus 102 can be any heating apparatus 102 suitable for heating a preform 110. In one embodiment, it can be a resistance heating apparatus. Alternatively, it can also be an infrared heating apparatus or a microwave heating apparatus. The heating apparatus 102 can be configured to heat the preform 110, or its surface, uniformly to a specific temperature. In one embodiment, the heating apparatus 102 can also be configured to generate a specific temperature distribution in the preform 110, for example along its longitudinal axis. If a specific temperature distribution is generated in the preform 110, a container 111 with a particularly uniform wall thickness distribution can be produced during the blow molding process, thus improving the quality of the containers 111 produced.

The blow molding machine 103 can be, for example, an extrusion blow molding machine or a stretch blow molding machine. In one embodiment, the blow molding machine 103 can be designed as a rotary machine, wherein the blow molding machine 103 can comprise a plurality of container holders which can be arranged along the circumference of the rotary machine. The blow molding machine 103 can be configured to form the preforms 110 produced by the production machine 101 into containers 111.

The containers 111 produced from the preforms 110 by the blow molding machine 103 can be bottles used in the beverage industry. Alternatively, however, the containers 111 can be any other type of container, such as a can, jar, cup, or tube, as used for example in the beverage, pharmaceutical, healthcare, or food industries, or any other container 111 which can be suitable for holding any liquid or pasty medium.

The control unit 104 can be designed as a computer, server, or any other computer unit and can be designed to control an operation of the container treatment system 100 or to control an operating parameter of at least one component of the container treatment system 100.

A component of the container treatment system 100 can be understood to mean, for example, the production machine 101 or the heating apparatus 102. However, components can also be understood to mean all other components of the container treatment system whose operation can be regulated by means of an operating parameter. Optionally, these are components that can influence the temperature of the preform 110 by regulating an operating parameter. For example, the component can also be one of the optional transport apparatuses 114, 115, 117.

To control the operation of the at least one component, the control unit 104 can be connected to the at least one component of the container treatment system 100 via a cable connection. This is the case, for example, in the embodiment discussed in connection with FIG. 1, where the control unit 104 is connected to the production machine 101 via a cable connection 105, to the heating apparatus 102 via a cable connection 107, and to the blow molding machine 103 via a cable connection 109. The control unit can also be connected to the optional transport apparatuses 114, 115 via cable connections 106, 108. Alternatively, it can also be provided that the control unit 104 is connected to the at least one component via a wireless connection, such as a WLAN connection.

Optionally, the control unit 104 can comprise a memory unit. In one embodiment, a database can be stored in the memory unit, wherein a corresponding operating parameter value for at least one component of the container treatment system 100 is assigned in the database to at least one specific actual temperature of the preform 110 at a specific position 112 upstream of the blow molding machine 103, so that a specific target temperature of the preform 110 at the blow molding machine 103 can be achieved. Alternatively, it can also be provided that a function is stored in the memory unit for at least one component, wherein an operating parameter value for the at least one component can be determined by means of the function based on an actual temperature of the preform 110 at a specific position 112 upstream of the blow molding machine 103 and a target temperature of the preform 110 at the blow molding machine 103, so that the target temperature of the preform 110 at the blow molding machine can be achieved.

In one embodiment, the control unit 104 for regulating the operating parameter of the at least one component can set the operating parameter to the operating parameter value determined by means of the database stored in the memory unit or by means of the function stored in the memory unit.

The actual temperature of the preform 110 is to be understood in particular as an actual temperature at a specific surface position of the preform 110, an actual temperature distribution, for example along a longitudinal axis of the preform 110, or an average temperature value of the preform. Analogous to the actual temperature, the target temperature can also be a target temperature at a specific surface position of the preform 110, a target temperature distribution, for example along a longitudinal axis of the preform 110, or a target mean temperature value.

In the embodiment discussed in connection with FIG. 1, the position upstream of the blow molding machine is selected as an inlet of the heating apparatus 112. This position is to be understood by way of example and not as limiting. This means that the operating parameter can also be regulated based on an actual temperature at any other position upstream of the blow molding machine. The position upstream of the blow molding machine 112 can generally be understood as any position through which the preform 110 passes during transport from the production machine 101 to the blow molding machine 103. For example, the position upstream of the blow molding machine 103 can also be an outlet of the production machine 101, an outlet of the heating apparatus 102, or an inlet of the blow molding machine 113. However, it can also be, for example, any position along the optional first and/or second transport apparatus 114, 115.

In the embodiment shown here, the target temperature of the preform 110 is to be reached at an inlet 113 of the blow molding machine 103. Alternatively, it can also be provided that the target temperature of the preform 110 is to be generated at any other position in the blow molding machine 103, for example at a position between the inlet of the blow molding machine 113 and a position in the blow molding machine 103 at which the preforms 110 are for example transferred into a blow mold. Alternatively, it can also be provided that the target temperature is to be generated at a position of a transport device associated with the blow molding machine 103, such as the optional second transport apparatus 115.

Optionally, the target and actual temperatures are determined and/or defined at the same point (e.g. at the inlet of the blow molding machine or at the inlet of the heating device).

A first temperature sensor 118 can be provided for determining the actual temperature of the preform 110. The first temperature sensor 118 can be, for example, an infrared temperature sensor by means of which the temperature of the preform 110 can be determined in contactless fashion. In particular, the first temperature sensor 118 can be configured to determine a temperature at a specific surface position of the preform 110, a temperature distribution of the preform 110, for example along its longitudinal axis, or an average temperature value of the preform 110. This embodiment of the first temperature sensor 118 is to be understood as exemplary, so that the first temperature sensor 118 can also be designed as any other type of temperature sensor which is suitable for determining the actual temperature of the preform 110.

In one embodiment, the first temperature sensor 118 can be mounted so as to be movable along the transport direction 116 of the preforms so that the temperature of the preform 110 can be determined at any position between the production machine 101 and the blow molding machine 103. The first temperature sensor 118 can be connected to the control unit 104 by means of a cable connection 120 (or alternatively a wireless connection).

Optionally, a second temperature sensor 119 can be provided to determine the temperature of the preform 110 at the blow molding machine 113. The second temperature sensor 119 can be provided as a control sensor to check whether the temperature of the preform 110 at the blow molding machine 113 actually corresponds to the target temperature. Like the first temperature sensor 118, the second temperature sensor 119 can also be configured to determine a temperature at a specific surface position of the preform 110, a temperature distribution of the preform 110, for example along its longitudinal axis, or an average temperature value of the preform 110. The second temperature sensor 119 can also be designed, for example, as an infrared temperature sensor, and can be connected to the control unit 104 by means of a cable connection 121 (alternatively by means of a wireless connection). Like the first temperature sensor 118, the second temperature sensor 119 can be formed as any type of temperature sensor suitable for determining the temperature of the preform 110.

The control unit 104 can thus determine an operating parameter value based on the actual temperature of the preform 110 at a position 112 upstream of the blow molding machine 103 determined by the optional first temperature sensor 118, using the database stored in the memory unit or the function stored in the memory unit, and regulate the operating parameter of the component based on the operating parameter value thus determined to achieve a target temperature of the preform 110 at the blow molding machine 113.

Optionally, it can also be provided that the control unit 104 uses the temperature of the preform 110 obtained by the second temperature sensor 119 to check whether the preform 110 actually has the desired target temperature at the blow molding machine 113. In the event that it was not possible to reach the desired target temperature despite regulation of the operating parameter, it can be provided in one embodiment that the control unit 104 readjusts the operating parameter of the component until the desired target temperature is reached at the blow molding machine 113. A control loop can be provided for this purpose, for example.

In one embodiment, the at least one component can comprise the heating apparatus 102. The heating apparatus 102 allows the temperature of the preform 110 to be flexibly and easily adjusted, so that regulating an operation of the heating apparatus 102 is particularly suitable for achieving a target temperature of the preform 110 at the blow molding machine 113. The operating parameter of the heating apparatus 102 can be, for example, a heating power, a heating profile, and/or a heating duration. These parameters have a direct influence on the temperature or temperature distribution of the preform 110 and therefore allow the temperature of the preform 110 to be set particularly easily and flexibly.

In one embodiment, it can also be provided that the at least one component comprises the production machine 101 for producing the preform 110. By regulating an operating parameter of the production machine 101, the temperature at which the finished preform 110 is output by the production machine 101 can be regulated, and in this way the temperature of the preform 110 at the blow molding machine 113 can also be influenced. The operating parameter of the production machine 101 can be, for example, a cycle time, an injection time, a lock to lock time, a production tool temperature, a melting temperature, a post-cooling temperature of the production machine, and/or a composition of a material for producing the preforms in the production machine 101. The material can be a plastics-based material, for example, which can comprise other components in addition to a plastics material. These operating parameters have a direct influence on the temperature of the preform 110 at which the preform is output by the production machine 101, and are therefore particularly suitable for achieving a target temperature of the preform 110 at the blow molding machine 113.

If the operating parameter is the composition of the material for producing the preforms in the production machine 101, the regulation of the operating parameter can be understood as a change in a composition of the material by adding at least one of an additive, plastics material flakes of a specific particle size, plastics material flakes of a specific particle size distribution, recyclate, recycled polyethylene terephthalate (PET), and/or color particles.

The selection just mentioned is not to be understood as limiting, so that other material components not explicitly mentioned here can also be added to the material in order to modify the material composition.

The production machine 101 can optionally comprise one or more storage units for this purpose, in which the above-mentioned material components and also any other suitable material component not explicitly mentioned here can be stored. The optional storage units can be in communication with a central storage device for the material for producing the preforms, which can be included in the production machine 101, and can be controlled by the control unit 104 such that an addition of at least one of the material components to the material stored in the central storage device for producing the preforms can be carried out based on the actual temperature of the preform 110 at a position 112 upstream of the blow molding machine 103 of the storage apparatus, and the material composition can be modified in this manner. By modifying the material composition, a change in the temperature at which the preforms leave the production machine 101 can be brought about and a target temperature of the preforms 110 at the blow molding machine 113 can be achieved.

In a further embodiment, the at least one component can comprise the first transport apparatus 114 arranged between the production machine 101 and the heating apparatus 102 and/or the second transport apparatus 115 arranged between the heating apparatus 102 and the blow molding machine 103. Since, for example, the transport speed at which the preforms 110 are transported from the production machine 101 to the heating apparatus 102 and/or from the heating apparatus 102 to the blow molding machine 103, or also the ambient conditions along the first 114 and/or second transport apparatus 115, can have an influence on the temperature of the preform 110, the target temperature of the preform 110 at the blow molding machine 113 can also be set by regulating an operating parameter of the first 114 and/or second transport apparatus 115.

The operating parameter of the first 114 and/or second transport apparatus 115 can be, for example, a transport speed, an ambient temperature prevailing at the first and/or second transport apparatus 114, 115, and/or a number of preforms 110 which can be transported by the first and/or second transport apparatus 114, 115 within a certain time interval. These parameters can be used to directly influence the temperature of the preforms 110 at the blow molding machine 113 and thus, by regulating them, achieve a target temperature of the preforms 110 at the blow molding machine 113.

In one embodiment, it can be sufficient to regulate an operating parameter of (exactly) one component in order to achieve a target temperature of the preform 110 at the blow molding machine 113. For example, it can be sufficient to regulate a heating power, a heating profile, or a heating duration of the heating apparatus or, alternatively, to regulate a parameter of the production machine 101.

In an alternative embodiment, it can also be provided that at least two different operating parameters of (exactly) one component are regulated in order to achieve a target temperature of the preform at the blow molding machine 113. This can be the case for example if the regulation of an operating parameter of a component is not sufficient to achieve the target temperature of the preforms 110 at the blow molding machine 113. For example, it can be provided that a heating power and a heating duration of the heating apparatus 102 are regulated, or, alternatively, at least two operating parameters of the production machine 101. Alternatively, it can also be provided that an operating parameter of at least two components of the container treatment system 100 is regulated in order to achieve a target temperature of the preform 110 at the blow molding machine 103. For example, it can be provided that an operating parameter of the production machine 101 and an operating parameter of the heating apparatus 102 are regulated in order to achieve the target temperature of the preform 110 at the blow molding machine 113. This can be the case, for example, if it is not possible to achieve the target temperature of the preform 110 at the blow molding machine 103 by regulating one or more operating parameters of just one component, for example the blow molding machine or the heating apparatus. This can either be the case if the operating parameter of one of the components is already set to a maximum value and therefore cannot be regulated higher or if the operating parameter would have to be regulated outside a predefined range. The regulation of the operating parameter outside the predefined range could, for example, have negative consequences for the quality of the preform produced. For example, excessive heating of the preform by the heating apparatus 102 could have a negative effect on the quality of the container 111 produced from the preform 110.

Furthermore, it can be provided that the regulation of an operating parameter of more than two components of the container treatment system 100 is provided in order to achieve the target temperature of the preform 110 at the blow molding machine 103. For example, it can be provided that an operating parameter of the production machine 101, an operating parameter of the first transport apparatus 114, an operating parameter of the heating apparatus 102, and an operating parameter of the second transport apparatus 115 are regulated in order to achieve the target temperature of the preform 110 at the blow molding machine 113. This can be the case for example if the regulation of an operating parameter of two components of the container treatment system 100 is not sufficient to achieve a target temperature of the preform 110 at the blow molding machine 103. If, for example, in the previously discussed exemplary embodiment it is not possible to achieve the target temperature of the preform 110 at the blow molding machine 113 by regulating an operating parameter of the production machine 101 and by regulating an operating parameter of the heating apparatus 102, then an operating parameter of the first 114 and/or the second transport apparatus 115 can additionally be regulated, for example.

For example, if the control unit 104 determines that the actual temperature of the preform 110 at the inlet of the heating apparatus 112 is too low or too high to reach the target temperature at the blow molding machine 113, the control unit 104 can regulate the operation of the production machine 101, the heating apparatus 102, and/or any other component of the container treatment system 100 based on the data stored in the memory unit in such a way that the temperature of the preform 110 is increased or lowered and the target temperature at the blow molding machine 113 is reached. As described above, the actual temperature of the preform 110 can also be determined by the control unit 104 at any other position between the production machine 101 and the blow molding machine 103, for example at the inlet of the blow molding machine 113, and the control unit 104 can, based on the actual temperature and the data stored in the memory unit, carry out a corresponding regulation of the operation of the production machine 101, the heating apparatus 102, and/or any other component of the container treatment system 100 in order to lower or increase the temperature of the preform 110 and to reach the target temperature at the blow molding machine 113.

Optionally, if the control unit 104 determines that the actual temperature of the preform 110 at the inlet of the heating apparatus 102 (or any other position between the production machine 101 and the blow molding machine 103, such as at the inlet of the blow molding machine 113) is too low or too high to reach the target temperature at the blow molding machine 113, it can be provided to first regulate an operation of the production machine 101, the heating apparatus 102, or any other component of the container treatment system 100 using the control unit 104 based on the data stored in the memory unit, in order to increase or decrease the temperature of the preform 110. If the control unit 104 then determines that the regulation of the operation of the one component (for example the production machine 101, the heating apparatus 102, or any other component) is not sufficient to achieve the target temperature of the preform 110 at the blow molding machine 113, then the control unit 104 can additionally regulate the operation of one of the other components of the container treatment system 100 based on the data stored in the memory unit in order to achieve the target temperature of the preform at the blow molding machine 113. This process can be repeated as often as required.

In one embodiment, the control unit 104 can, for example, determine that the actual temperature of the preform 110 at the inlet of the blow molding machine 113 is too low or too high, and in a first step, based on the data stored in the memory unit, can regulate an operation of the production machine 101, for example increase or decrease a production tool temperature of the production machine, in order to reach the target temperature of the preform 110 at the blow molding machine 113. If the control unit 104 determines in a second step that the actual temperature of the preform 110 at the inlet of the blow molding machine 113 is still too low or too high (i.e. below or above the target temperature), the control unit 104 can additionally regulate the operation of the heating apparatus 102, for example based on the data stored in the memory unit, for example increase or decrease the heating power of the heating apparatus 102, so that the target temperature can be reached at the inlet of the blow molding machine 113.

1. A container treatment system for regulating a temperature of a preform, wherein the container treatment system comprises a production machine for producing the preform, a heating apparatus arranged downstream of the production machine, a blow molding machine arranged downstream of the heating apparatus, and a control unit, wherein the control unit is designed to regulate an operating parameter of at least one component of the container treatment system based on an actual temperature of the preform at a position upstream of the blow molding machine in order to achieve a target temperature of the preform at the blow molding machine.

2. The container treatment system according to claim 1, wherein the at least one component comprises the heating apparatus and the operating parameter is a heating power, a heating profile, and/or a heating duration of the heating apparatus.

3. The container treatment system according to claim 1, wherein the at least one component comprises the production machine for producing the preform.

4. The container treatment system according to claim 3, wherein the operating parameter is a cycle time, an injection time, a lock to lock time, a production tool temperature, a melting temperature, a post-cooling temperature of the production machine, and/or a composition of a material for producing the preforms in the production machine.

5. The container treatment system according to claim 1, wherein the control unit is configured to regulate an operating parameter of the heating apparatus and an operating parameter of the production machine when the actual temperature is below or above a threshold value.

6. The container treatment system according to claim 1, wherein the at least one component comprises a first transport apparatus arranged between the production machine and the heating apparatus and/or a second transport apparatus arranged between the heating apparatus and the blow molding machine.

7. The container treatment system according to claim 6, wherein the operating parameter is a transport speed, an ambient temperature prevailing at the first and/or second transport apparatus, and/or a number of preforms which are transported by the first and/or second transport apparatus within a particular time interval.

8. A method for regulating a temperature of a preform in a container treatment system, wherein the container treatment system comprises a production machine for producing the preform, a heating apparatus arranged downstream of the production machine, a blow molding machine arranged downstream of the heating apparatus, and a control unit, wherein the control unit regulates an operating parameter of at least one component of the container treatment system based on an actual temperature of the preform at a position upstream of the blow molding machine so that a target temperature of the preform is achieved at the blow molding machine.

9. The method according to claim 8, wherein the at least one component comprises the heating apparatus and the operating parameter is a heating power, a heating profile, and/or a heating duration of the heating apparatus.

10. The method according to claim 8, wherein the at least one component comprises the production machine for producing the preform.

11. The method according to claim 10, wherein the operating parameter is a cycle time, an injection time, a lock to lock time, a production tool temperature, a melting temperature, a post-cooling temperature of the production machine, and/or a composition of a material for producing the preforms in the production machine.

12. The method according to claim 8, wherein an operating parameter of the heating apparatus and an operating parameter of the production machine are regulated by the control unit when the actual temperature is below or above a threshold value.

13. The method according to claim 8, wherein the at least one component comprises a first transport apparatus arranged between the production machine and the heating apparatus and/or a second transport apparatus arranged between the heating apparatus and the blow molding machine.

14. The method according to claim 13, wherein the operating parameter is a transport speed of the first and/or second transport apparatus, an ambient temperature prevailing at the first and/or second transport apparatus, and/or a number of preforms which are transported by the first and/or second transport apparatus.

15. The method according to claim 8, wherein the actual and/or target temperature is an actual and/or target temperature distribution of the preform.

16. The container treatment system according to claim 1, wherein the production machine is an injection molding machine.

17. The method according to claim 8, wherein the production machine is an injection molding machine.
